(19) United States
(12) Patent Application Publication
(10) Pub. No.: US 2014/0095916 A1
(43) Pub. Date: Apr. 3, 2014

(54) POWER SUPPLY CIRCUIT FOR PCI-E AND MOTHERBOARD HAVING SAME

(71) Applicants: Hon Hai Precision Industry Co., Ltd., New Taipei (TW); Hong Fu Jin Precision Industry (WuHan) Co., Ltd., Wuhan (CN)

(72) Inventor: CHUN-SHENG CHEN, New Taipei (TW)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/037,391

(22) Filed: Sep. 26, 2013

(30) Foreign Application Priority Data
Sep. 28, 2012 (CN) 2012103670167

(51) Int. Cl. G06F 1/32

(52) U.S. Cl. CPC G06F 1/3253
USPC 713/324

(57) ABSTRACT

An exemplary power supply circuit for a PCI-E on a motherboard includes a first power supply, a detection unit, a power control unit, and a discharge unit. The first power supply supplies power for the PCI-E via a power pin of the PCI-E. The detection unit detects whether the motherboard receives a soft shutdown command. The power control unit cuts off or maintains an electrical connection between the first power supply and the PCI-E under control of the detection unit. The discharge unit discharges residual electrical charges in the PCI-E when the motherboard receives the soft shutdown command.

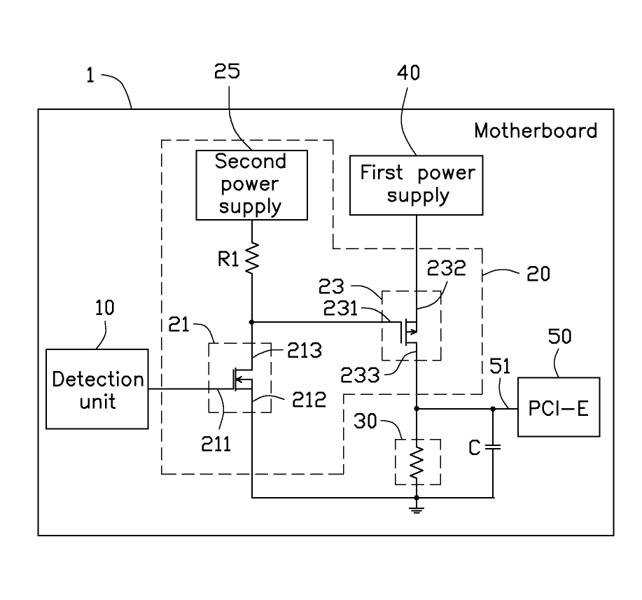

### BACKGROUND

1. Technical Field

The present disclosure relates to a power supply circuit for a peripheral component interconnect express (PCI-E) and a motherboard having the power supply circuit.

2. Description of Related Art

PCI-E is a universal bus interface often used in a motherboard. A power pin of the PCI-E is usually electrically connected to an external power supply to supply power for the PCI-E. The power pin is also electrically connected to a filter capacitor. However, when the motherboard switches from a working state to a soft shutdown state, the external power supply supplies power for the PCI-E continually, which wastes energy.

Therefore, what is needed is a means to overcome the above described shortcoming.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

The FIGURE is a detailed circuit diagram of a motherboard including a power supply for PCI-E.

### DETAILED DESCRIPTION

Reference will be made to the drawings to describe various embodiments.

The FIGURE is a detailed circuit diagram of a motherboard 1 including a power supply system for a peripheral component interconnect express (PCI-E). The motherboard 1 includes a first power supply 40, a filter capacitor C, and a PCI-E 50. The first power supply 40 supplies power for the PCI-E 50 via a power pin 51 of the PCI-E 50. The power pin 51 is grounded via the filter capacitor C. In the embodiment, the first power supply 40 supplies 3.3V for the PCI-E 50.

The motherboard 1 further includes a detection unit 10, a power control unit 20, and a discharge unit 30. The detection unit 10 detects whether the motherboard 1 receives a soft shutdown command from a operating system. The power control unit 20 is electrically connected to the detection unit 10, and determines an electrical connection between the first power supply 40 and the PCI-E 50 under control of the detection unit 10. The power control unit 20 cuts off the electrical connection between the first power supply 40 and the PCI-E 50 when the detection unit 10 determines that the motherboard 1 receives the soft shutdown command. The discharge unit 30 is electrically connected to the filter capacitor C in parallel. The discharge unit 30 discharges residual electrical charges in the filer capacitor C and the PCI-E 50.

When the motherboard 1 receives the soft shutdown command, the detection unit 10 outputs a first control signal. The power control unit 20 cuts off the electrical connection between the first power supply 40 and the PCI-E 50, and the discharge unit 30 discharges residual electrical charges in the filter C and the PCI-E 50. When the motherboard 1 does not receive the soft shutdown command, the detection unit 10 outputs a second control signal. The power control unit 20 maintains the electrical connection between the first power supply 40 and the PCI-E 50.

In the embodiment, the first and second control signal is pulse width modulation (PWM) signal.

The power control unit 20 includes a first transistor 21, a second transistor 23, a resistor R1, and a second power supply 25. The first transistor 21 includes a first control terminal 211, a first conducting terminal 212, and a second conducting terminal 213. The first control terminal 211 is electrically connected to the detection unit 10 to receive the first and second control signal. The first conducting terminal 212 is grounded. The second conducting terminal 213 is electrically connected to the second power supply 25 via the resistor R1. The second transistor 23 includes a second control terminal 231, a third conducting terminal 232, and a fourth conducting terminal 233. The second control terminal 231 is electrically connected to the second conducting terminal 213. The third conducting terminal 232 is electrically connected to the first power supply 40. The fourth conducting terminal 233 is grounded via the discharge unit 30. In the embodiment, the second power supply 25 is a standby power having a 5V voltage.

In the embodiment, the first transistor 21 is an n-channel metal oxide semiconductor (NMOS) transistor. The first control terminal 211 is a gate electrode of the NMOS transistor. The first conducting terminal 212 is a source electrode of the NMOS transistor. The second conducting terminal 213 is a drain electrode of the NMOS transistor. The second transistor 23 is a p-channel metal oxide semiconductor (PMOS) transistor. The second control terminal 231 is a gate electrode of the PMOS transistor. The third conducting terminal 232 is a source electrode of the PMOS transistor. The fourth conducting terminal 233 is a drain electrode of the PMOS transistor.

In the embodiment, the discharge unit 30 is a resistor. In other embodiments, the discharge unit 30 can be a diode. An anode of the diode is electrically connected the power pin 51 and a cathode of the diode is grounded.

In operation, when the motherboard 1 receives the soft shutdown command and the detection unit 10 outputs the first control signal to the first control terminal 211. The first transistor 21 turns on, thus the second control terminal 231 receives a logic low signal and the second transistor 23 turns off. Thus the second transistor 23 cuts off the electrical connection between the first power supply 40 and the power pin 51. The discharge unit 30 discharges the residual charge in the filter capacitor C and the PCI-E. In the embodiment, the first control signal is a logic low signal (e.g. logic 0).

When the motherboard 1 does not receive the soft shutdown command, the detection unit 10 outputs the second signal to the first control terminal 211. The first transistor 21 turns off, thus the second control terminal 231 receives a logic high signal and the second transistor 23 turns on. Thus, the second transistor maintains the electrical connection between the first power supply 40 and the power pin 51.

In summary, the power supply for the PCI-E may cut off the electrical connection between the power supply and PCI-E and discharge the residual charge in the filter and the PCI-E, thus reducing energy waste when the motherboard 1 is in the soft shutdown state.

It is to be understood that even though numerous characteristics and advantages of the present embodiments have been set forth in the foregoing description, with details of the structures and functions of the embodiments, the disclosure is illustrative only; and changes may be in detail, especially in the matters of arrangement of parts within the principles of the embodiments to the full extent indicated by the broad general meaning of the terms in which the appended claims are expressed.

What is claimed is:

1. A power supply circuit for a peripheral component interconnect express (PCI-E) on a motherboard, comprising:
a first power supply supplying power for the PCI-E via a power pin of the PCI-E;
a detection unit detecting whether the motherboard receiving a soft shutdown command;
a power control unit cutting off an electrical connection between the first power supply and the PCI-E when the detection unit detects that the motherboard receives the soft shutdown command, and maintaining the electrical connection between the first power supply and the PCI-E when the detection unit detects that the motherboard does not receive the soft shutdown command; and
a discharge unit discharging residual electrical charges in the PCI-E when the motherboard receives the soft shutdown command.

2. The power supply circuit of claim 1, further comprising a filter capacitor electrically connected to the discharge unit in parallel.

3. The power supply circuit of claim 2, wherein the power control unit comprises a first transistor, a resistor, and a second power supply, the first transistor comprises a first control terminal, a first conducting terminal, and a second conducting terminal, and the first control terminal is electrically connected to the detection unit, the first conducting terminal is grounded, and the second conducting terminal is electrically connected to the second power supply via the resistor.

4. The power supply circuit of claim 3, wherein the power control unit further comprises a second transistor having a second control terminal, a third conducting terminal, and a fourth conducting terminal, the second control terminal is electrically connected to the second conducting terminal, the third conducting terminal is electrically connected to the first power supply, and the fourth conducting terminal is grounded via the discharge unit.

5. The power supply circuit of claim 4, wherein the first transistor is an n-channel metal oxide semiconductor (NMOS) transistor, the first control terminal is a gate electrode of the NMOS transistor, the first conducting terminal is a source electrode of the NMOS transistor, and the second conducting terminal is a drain electrode of the NMOS transistor.

6. The power supply circuit of claim 4, wherein the second transistor is a p-channel metal oxide semiconductor (PMOS) transistor, the second control terminal is a gate electrode of the PMOS transistor, the third conducting terminal is a source electrode of the PMOS transistor, and the fourth conducting terminal is a drain electrode of the PMOS transistor.

7. A power supply circuit for a peripheral component interconnect express (PCI-E) on a motherboard, comprising:
a first power supply supplying power for the PCI-E via a power pin of the PCI-E;
a detection unit detecting whether the motherboard receiving a soft shutdown command and outputting a first control signal when the motherboard receives the soft shutdown command;
a power control unit cutting off an electrical connection between the first power supply and the PCI-E under control of the first control signal; and
a discharge unit discharging residual electrical charges in the PCI-E when the detection unit outputs the first control signal.

8. The power supply circuit of claim 7, wherein when the motherboard does not receive the soft shutdown command, the detection unit outputs a second control signal, and the power control unit maintains the electrical connection between the first power supply and the PCI-E.

9. The power supply circuit of claim 7, further comprising a filter capacitor electrically connected to the discharge unit in parallel, and the discharge unit discharging any residual electrical charges in the filter capacitor when the motherboard receives the soft shutdown command.

10. The power supply circuit of claim 7, wherein the power control unit comprises the power control unit comprises a first transistor, and a second power supply, the first transistor comprises a first control terminal, a first conducting terminal, and a second conducting terminal, and the first control terminal is electrically connected to the detection unit, the first conducting terminal is grounded, and the second conducting terminal is electrically connected to the second power supply via the resistor.

11. The power supply circuit of claim 10, wherein the power control unit further comprises a second transistor having a second control terminal, a third conducting terminal, and a fourth conducting terminal, the second control terminal is electrically connected to the second conducting terminal, the third conducting terminal is electrically connected to the first power supply, the fourth conducting terminal is grounded via the discharge unit.

12. The power supply circuit of claim 11, wherein when the motherboard receives the soft shutdown command and the detection unit outputs the first control signal to the first control terminal, the first transistor turns on, thus the second control terminal receives a logic low signal and the second transistor turns off and the second transistor cuts off the electrical connection between the first power supply and the power pin, and the discharge unit discharges the residual charge in the filter capacitor and the PCI-E.

13. The power supply circuit of claim 11, wherein when the motherboard does not receive the soft shutdown command, the detection unit outputs the second signal to the first control terminal, and the first transistor turns off, thus the second control terminal receives a logic high signal and the second transistor turns on and the second transistor maintains the electrical connection between the first power supply and the power pin.

14. A motherboard, comprising:
a peripheral component interconnect express (PCI-E);
a first power supply supplying power for the PCI-E via a power pin of the PCI-E;
a detection unit detecting whether the motherboard receiving a soft shutdown command;
a power control unit cutting off an electrical connection between the first power supply and the PCI-E when the detection unit detects that the motherboard receives the soft shutdown command, and maintaining the electrical connection between the first power supply and the PCI-E when the detection unit detects that the motherboard does not receive the soft shutdown command; and
a discharge unit discharging residual electrical charges in the PCI-E when the motherboard receives the soft shutdown command.

15. The motherboard of claim 14, further comprising a filter capacitor electrically connected to the discharge unit in parallel.

16. The motherboard of claim 15, wherein the power control unit comprises a first transistor, a resistor, and a second power supply, the first transistor comprises a first control terminal, a first conducting terminal, and a second conducting terminal, and the first control terminal is electrically connected to the detection unit, the first conducting terminal is grounded, and the second conducting terminal is electrically connected to the second power supply via the resistor.

17. The motherboard of claim 16, wherein the power control unit further comprises a second transistor having a second control terminal, a third conducting terminal, and a fourth conducting terminal, the second control terminal is electrically connected to the second conducting terminal, the third conducting terminal is electrically connected to the first power supply, the fourth conducting terminal is grounded via the discharge unit.

18. The motherboard of claim 17, wherein the first transistor is an n-channel metal oxide semiconductor (NMOS) transistor, the first control terminal is a gate electrode of the NMOS transistor, the first conducting terminal is a source electrode of the NMOS transistor, and the second conducting terminal is a drain electrode of the NMOS transistor.

19. The motherboard of claim 17, wherein the second transistor is a p-channel metal oxide semiconductor (PMOS) transistor, the second control terminal is a gate electrode of the PMOS transistor, the third conducting terminal is a source electrode of the PMOS transistor, and the fourth conducting terminal is a drain electrode of the PMOS transistor.
